(19) United States
(12) Patent Application Publication
(10) Pub. No.: US 2007/0202421 A1
(43) Pub. Date: Aug. 30, 2007

(54) Process For Preparing A Polymeric Relief Structure

(76) Inventors: Dick Broer, Geldrop (NL); Cornelis Bastiaansen, Montfort (NL); Carlos Sanchez, Eindhoven (NL)

Correspondence Address: NIXON & VANDERHYE, PC, 901 NORTH GLEBE ROAD, 11TH FLOOR, ARLINGTON, VA, 22203, US

(21) Appl. No.: 10/589,531

(22) PCT Filed: Feb. 19, 2004
(86) PCT No.: PCT/NL04/00127

§ 371 Date: Nov. 7, 2006

(51) Int. Cl. G03G 13/00

(52) U.S. Cl. 430/31

(57) ABSTRACT

The invention deals with a process for the preparation of a polymeric relief structure via electromagnetic radiation. In the process a compound is used that reduces the interfacial tension of the coated substrate. As a result the aspect ratio as well as the curvature of the surface are enhanced, and therefore are beneficial for optical components and for replication purposes.

The present invention relates to a process for the preparation of a polymeric relief structure by
a) coating a substrate with a coating comprising one or more radiation-sensitive ingredients,
b) locally treating the coated substrate with electromagnetic radiation having a periodic or random radiation-intensity pattern, forming a latent image,
c) polymerizing and/or crosslinking the resulting coated substrate,

Such a process, hereinafter also to be called “photo-embossing is known from “photo-embossing as a tool for complex surface relief structures” De Witz, Christiane; Broer, Dirk J., Abstracts of Papers, 226^{th} ACS National Meeting, New York, N.Y., United States, Sept. 7-11, 2003.

Polymers in use in optical systems for data transport, storage and displays are nowadays of great interest. By structuring the surface of a polymer film or layer, light that passes these layers can be controlled. For instance if the surface structure contains small semi-sphere like elements a lens array is obtained that may focus transmitting light. Such an element is for instance useful in a backlight of a liquid crystal display to focus light on the transparent area of the display. For these types of applications it is often necessary to control the shape of the surface profiles down to the micrometer region. Also regular patterns of surface structures may diffract light such that a single beam, upon transmission, is split up in multiple beams that for instance can be used as beam splitter in telecommunication devices. Surface structures are also important to control reflection of light. This can successfully be applied to suppress specular reflection of a surface. This so-called anti-glare effect is for instance applied on the front screen of a television set. But also be used for applications such glazing, car finishes, etc. A polymer film, with well-defined surface profiles, may be provided with a conformal reflective film such as evaporated aluminum or sputtered silver. Incident light falling on this mirror is, upon reflection, distributed in space in a very controlled way. This is for instance used to make internal diffusive reflectors for reflective liquid crystal displays. Another application of surface profiles is for creating anti-fouling structures known as the Lotus effect. Thereto surface profiles with dimensions smaller than 1 micrometer are needed.

Electromagnetic-radiation induced polymerization, like UV photo-polymerization is a method to prepare devices from e.g. a mixture of two (meth)acrylate monomers and a photo-initiator. The polymerization reaction is initiated only in those regions where the UV light can activate the photo-initiator. In addition, it is possible to vary the light intensity spatially and vary the polymerization speed accordingly. Differences in the monomer reactivity, size or length, cross-linking ability, and energetic interaction result in gradients in the monomer chemical potentials. These chemical potentials form the driving force for monomer migration and for polymer swelling in the illuminated regions. The monomer diffusion coefficients determine the time-scale on which this migration takes place. Subsequently, uniform UV illumination with a higher intensity than during the patterned UV illumination is used to polymerize the entire film.

Patterned UV photo-polymerization of a mixture of two liquid monomers thus results in a polymer structure. This can be done holographically or lithographically. For holography, the interference pattern of two coherent light beams generates regions of high low light intensity. For lithography, a photo-mask is used to produce these intensity differences. If for instance a striped mask is uses, a grating is produced. If a mask with circular holes is used, a microlens structure is formed. Differences in the refractive index are caused by lateral variations of monomer-unit concentrations in the polymer.

A better method to create surface structure is to use a blend that basically consists of a blend of a polymer, a monomer and a initiator. The polymer can be a single polymeric material but may also be a blend of more than one polymer. Similarly the monomer may be a single compound, but may also be consisting several monomeric materials. The initiator preferably is a photoinitiator, but sometimes is a mixture of a photoinitiator and a thermal initiator. This mixture is generally dissolved in an organic solvent in order to enhance processing, e.g. formation of thin films by spin coating. The blending conditions as well as the properties of the polymer and monomer are chosen such that after evaporation of the solvent a solid film is formed. In general this allows that upon patterned exposure with UV light a latent image is formed. The latent image can be developed into a surface profile by heating where polymerization and diffusion occur simultaneously, thus increasing the materials volume at the exposed area or vica versa which results in a surface deformation.

A weakness of this process is that the resulting relief structure, produced with such a photo-embossing process, has a rather low aspect ratio. The aspect ratio (AR) being defined as the ratio between the relief height and the distance (or pitch) between neighbouring reliefs. The edges of the relief structure are not sharp or not accurately reproduced, as a result of which the optical function or other functionality that is aimed at is less optimal.

The present invention provides an improved process for preparing a polymeric relief structure, and is characterized in that during step c) of the photo-embossing a compound (Cs) is present that reduces the interfacial surface tension of the coated substrate.

As a result, relief structures with an enhanced relief aspect ratio (the improvement typically showing an increase of a factor 2), as well as much sharper edged relief, are obtained.

The compound Cs, used to reduce the interfacial surface tension, can be applied in at least two distinct ways. The first way is in a process, wherein Cs is applied to the coated substrate resulting from step b) of the present process, after which step c) is executed. The second way is in a process, in which the Cs is already present in the coating used in step a) of the present process. As a result hereof, Cs is present in step b) as well as in step c).

The coating used in step a) of the present process comprises one or more radiation sensitive ingredients, which in general are C═C unsaturated monomers, polymerizable via electromagnetic radiation. These ingredients can be used as such, but also in the form of a solution.

The coating may be applied onto the substrate by any process known in the art of (wet) coating deposition. Examples of suitable processes are spin coating, dip coating, spray coating, flow coating, meniscus coating, doctor's blading, capillary coating, and roll coating.

Typically, the radiation sensitive ingredients are mixed, preferably with at least one solvent and, optionally, crosslinking initiator to prepare a mixture that is suitable for application to the substrate using the chosen method of application.

In principle, a wide variety of solvents may be used. However, the combination of the solvents and all other materials present in the mixture should preferentially form stable suspensions or solutions.

Preferably the solvent used is evaporated after applying the coating onto the substrate. In the process according to the invention, optionally the coating may after application to the substrate be heated or treated in vacuum to aid evaporation of the solvent.

Examples of solvents that are suitable are 1,4-dioxane, acetone, acetonitrile, chloroform, chlorophenol, cyclohexane, cyclohexanone, cyclopentanone, dichloromethane, diethyl acetate, diethyl ketone, dimethyl carbonate, dimethylformamide, dimethylsulphoxide, ethanol, ethyl acetate, m-cresol, mono- and di-alkyl substituted glycols, N,N-dimethylacetamide, p-chlorophenol, 1,2-propanediol, 1-pentanol, 1-propanol, 2-hexanone, 2-methoxyethanol, 2-methyl-2-propanol, 2-octanone, 2-propanol, 3-pentanone, 4-methyl-2-pentanone, hexafluoroisopropanol, methanol, methyl acetate, butyl acetate, methyl acetoacetate, methyl ethyl ketone, methyl propyl ketone, n-methylpyrrolidone-2, n-pentyl acetate, phenol, tetrafluoro-n-propanol, tetrafluoroisopropanol, tetrahydrofuran, toluene, xylene and water. Alcohol, ketone and ester based solvents may also be used, although the solubility of acrylates may become an issue with high molecular weight alcohols. Halogenated solvents (such as dichloromethane and chloroform) and hydrocarbons (such as hexanes and cyclohexanes), are suitable.

The mixtures preferably contain a polymeric material. In fact each polymer can be used that forms a homogenous mixture with the other components. Well-studied polymers are polymethylmethacrylate, polymethylacrylate, polystyrene, polybenzylmethacrylate, polyisobornylmethacrylate. But also many other polymers may be applied as well. The mixture also contains a monomeric compound, being a compound of relatively low molecular weight, i.e. smaller than 1500, that upon contact with reactive particles, i.e. free radicals or cationic particles, polymerize. In a preferred embodiment the monomer or one of the monomers of a monomer mixture contains more than one polymerizing group such that upon polymerization a polymer network is formed. Further in the preferred embodiment the monomers are molecules containing reactive group of the following classes: vinyl, acrylate, methacrylate, epoxide, vinylether or thiol-ene. The mixture also contains a photosensitive component being the compound that upon exposure to actinic radiation generates the reactive particle, i.e. the free-radicals or cationic particles.

Examples of monomers suitable for use as polymerizing ingredient and having at least two crosslinkable groups per molecule include monomers containing (meth)acryloyl groups such as trimethylolpropane tri(meth)acrylate, pentaerythritol (meth)acrylate, ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, polybutanediol di(meth)acrylate, tripropyleneglycol di(meth)acrylate, glycerol tri(meth)acrylate, phosphoric acid mono- and di(meth)acrylates, C₇-C₂₀ alkyl di(meth)acrylates, trimethylolpropanetrioxyethyl (meth)acrylate, tris(2-hydroxyethyl)isocyanurate tri(meth)acrylate, tris(2-hydroxyethyl)isocyanurate di(meth)acrylate, pentaerythritol tri(meth)acrylate, pentaerythritol tetra(meth)acrylate, dipentaerythritol monohydroxy pentacrylate, dipentaerythritol hexacrylate, tricyclodecane diyl dimethyl di(meth)acrylate and alkoxylated versions, preferably ethoxylated and/or propoxylated, of any of the preceding monomers, and also di(meth)acrylate of a diol which is an ethylene oxide or propylene oxide adduct to bisphenol A, di(meth)acrylate of a diol which is an ethylene oxide or propylene oxide adduct to hydrogenated bisphenol A, epoxy (meth)acrylate which is a (meth)acrylate adduct to bisphenol A of diglycidyl ether, diacrylate of polyoxyalkylated bisphenol A, and triethylene glycol divinyl ether, adduct of hydroxyethyl acrylate, isophorone diisocyanate and hydroxyethyl acrylate (HIH), adduct of hydroxyethyl acrylate, toluene diisocyanate and hydroxyethyl acrylate (HTH), and amide ester acrylate.

Examples of suitable monomers having only one crosslinking group per molecule include monomers containing a vinyl group, such as N-vinyl pyrrolidone, N-vinyl caprolactam, vinyl imidazole, vinyl pyridine; isobornyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, benzyl (meth)acrylate, 4-butylcyclohexyl (meth)acrylate, acryloyl morpholine, (meth)acrylic acid, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, caprolactone acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, tridecyl (meth)acrylate, undecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, benzyl (meth)acrylate, phenoxyethyl (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone (meth)acrylamide, beta-carboxyethyl (meth)acrylate, phthalic acid (meth)acrylate, isobutoxymethyl (meth)acrylamide, N,N-dimethyl (meth)acrylamide, t-octyl (meth)acrylamide, dimethylaminoethyl (meth)acrylate, diethylaminoethyl (meth)acrylate, butylcarbamylethyl (meth)acrylate, n-isopropyl (meth)acrylamide fluorinated (meth)acrylate, 7-amino-3,7-dimethyloctyl (meth)acrylate, N, N-diethyl (meth)acrylamide, N, N-dimethylaminopropyl (meth)acrylamide, hydroxybutyl vinyl ether, lauryl vinyl ether, cetyl vinyl ether, 2-ethylhexyl vinyl ether; and compounds represented by the following formula (I)
CH₂=C(R⁶)-COO(R⁷O)m−R⁸ (I)
wherein R⁶ is a hydrogen atom or a methyl group; R⁷ is an alkylene group containing 2 to 8, preferably 2 to 5 carbon atoms; and m is an integer from 0 to 12, and preferably from 1 to 8; R⁸ is a hydrogen atom or an alkyl group containing 1 to 12, preferably 1 to 9, carbon atoms; or, R⁸ is a tetrahydrofuran group—comprising alkyl group with 4-20 carbon atoms, optionally substituted with alkyl groups with 1-2 carbon atoms; or R⁸ is a dioxane group—comprising alkyl group with 4-20 carbon atoms, optionally substituted with methyl groups; or R⁸ is an aromatic group, optionally substituted with C₁-C₁₂ alkyl group, preferably a C₈-Cg alkyl group, and alkoxylated aliphatic monofunctional monomers, such as ethoxylated isodecyl (meth)acrylate, ethoxylated lauryl (meth)acrylate, and the like.

Oligomers suitable for use as a radiation sentitive ingredient are for example aromatic or aliphatic urethane acrylates or oligomers based on phenolic resins (ex. bisphenol epoxy diacrylates), and any of the above oligomers chain extended with ethoxylates. Urethane oligomers may for example be based on a polyol backbone, for example polyether polyols, polyester polyols, polycarbonate polyols, polycaprolactone polyols, acrylic polyols, and the like. These polyols may be used either individually or in combinations of two or more. There are no specific limitations to the manner of polymerization of the structural units in these polyols. Any of random polymerization, block polymerization, or graft polymerization is acceptable. Examples of suitable polyols, polyisocyanates and hydroxylgroup-containing (meth)acrylates for the formation of urethane oligomers are disclosed in WO 00/18696, which is incorporated herein by reference.

Combinations of compounds that together may result in the formation of a crosslinked phase and thus in combination are suitable to be used as the reactive diluent are for example carboxylic acids and/or carboxylic anhydrides combined with epoxies, acids combined with hydroxy compounds, especially 2-hydroxyalkylamides, amines combined with isocyanates, for example blocked isocyanate, uretdion or carbodiimide, epoxies combined with amines or with dicyandiamides, hydrazinamides combined with isocyanates, hydroxy compounds combined with isocyanates, for example blocked isocyanate, uretdion or carbodiimide, hydroxy compounds combined with anhydrides, hydroxy compounds combined with (etherified) methylolamide (“amino-resins”), thiols combined with isocyanates, thiols combined with acrylates or other vinylic species (optionally radical initiated), acetoacetate combined with acrylates, and when cationic crosslinking is used epoxy compounds with epoxy or hydroxy compounds.

Further possible compounds that may be used as a radiation sensitive ingredient are moisture curable isocyanates, moisture curable mixtures of alkoxy/acyloxy-silanes, alkoxy titanates, alkoxy zirconates, or urea-, urea/melamine-, melamine-formaldehyde or phenol-formaldehyde (resol, novolac types), or radical curable (peroxide- or photo-initiated) ethylenically unsaturated mono- and polyfunctional monomers and polymers, e.g. acrylates, methacrylates, maleate/vinyl ether), or radical curable (peroxide- or photo-initiated) unsaturated e.g. maleic or fumaric, polyesters in styrene and/or in methacrylates.

Preferably, the applied coating also comprises a polymer, preferably of the same nature as the polymer resulting from the crosslinking of the radiation sensitive ingredients. Preferably, this polymer has a weight-averaged molecular weight (Mw) of at least 20,000 g/mol.

The polymer, when used in the coating step a), preferably has a glass transition temperature of at least 300 K. Preferably, the polymer in the coating used in step a) is dissolved in the monomer(s), present in the radiation sensitive coating of step a) or in the solvent used in the coating of step a) of the process of the present invention.

A wide variety of substrates may be used as a substrate in the process according to the invention. Suitable substrates are for example flat or curved, rigid or flexible polymeric substrates, including films of for example polycarbonate, polyester, polyvinyl acetate, polyvinyl pyrollidone, polyvinyl chloride, polyimide, polyethylene naphthalate, polytetrafluoro-ethylene, nylon, polynorbornene or amorphous solids, for example glass or crystalline materials, such as for example silicon or gallium arsenide. Metallic substrates may also be used. Preferred substrates for use in display applications are for example glass, polynorbornene, polyethersulfone, polyethyleneterephtalate, polyimide, cellulose triacetate, polycarbonate and polyethylenenaphthalate.

An initiator may be present in the coating to initiate the crosslinking reaction. The amount of initiator may vary between wide ranges. A suitable amount of initiator is for example between above 0 and 5 wt % with respect to total weight of the compounds that take part in the crosslinking reaction.

When UV-crosslinking is used to initiate crosslinking, the mixture preferably comprises a UV-photo-initiator. A photo-initiator is capable of initiating a crosslinking reaction upon absorption of light; thus, UV-photo-initiators absorb light in the Ultra-Violet region of the spectrum. Any known UV-photo-initiators may be used in the process according to the invention.

Preferably the polymerization initiator comprises a mixture of a photo initiator and a thermal initiator.

Any cross-linking method that may cause the coating to polymerize and/or crosslink so that a final coating is formed is suitable to be used in the process according to the invention. Suitable ways to initiate crosslinking are for example electron beam radiation, electromagnetic radiation (UV, Visible and Near IR), thermally and by adding moisture, in case moisture-curable compounds are used. In a preferred embodiment crosslinking is achieved by UV-radiation. The UV-crosslinking may take place through a free radical mechanism or by a cationic mechanism, or a combination thereof. In another preferred embodiment the crosslinking is achieved thermally.

In step b) of the process of the present invention the coated substrate resulting form process step a) is locally treated with electromagnetic radiation having a periodic or latent radiation intensity pattering as a result of which a latent image is formed. In one preferred embodiment, this treatment is performed using UV-light in combination with a mask. In another preferred embodiment, this treatment is performed by the use of light interference/holography. Still another embodiment is by the use of electron beam lithography.

The essential feature of the present invention is the use of a compound (Cs) that reduces the interfacial tension between the photo-polymer and its surroundings. For this term, reference is given to the publication “Polymer Surfaces” from F. Garbossi et. al, Wiley 1994, pages 183-184, where a description is given how to determine the interfacial tension of a solid with air by using a Zisman-plot. In order to achieve and evaluate the benefits of the present invention, it is advisable to first determine the interfacial tension of a coated substrate (with air), obtained with all the ingredients except Cs, and compare the so obtained value with the interfacial tension of the coated substrate obtained with all the ingredients (thus including Cs) (See Fryer et al. Macromolecules, 2001, 34, page 5627-5634). Preferably, the Cs reduces the interfacial tension with at least 10 mJ/m².

Ingredients that are suitable as compound Cs are those compounds that lower the surface tension of the coated substrate.

The Cs needs not to be miscible and soluble in the polymeric coating.

This means that when a polar polymeric coating is used, the Cs needs to be apolar; whereas when an apolar coating is used, the Cs needs to be polar. In preference, the Cs has one or more of the following properties:

non-elastic or non-visco-elastic
low viscosity
not or hardly volatile
extractable/removable from the coated substrate after process step c).
   As a result preference is given to the use as compound Cs of an oil. As an apolar oil can be mentioned: silicon oil, parafinic oil, (per)- fluorinated oil. As a polar oil can be mentioned: glycerol, (poly-) ethylene glycol.

The use of Cs is preferentially in an amount of 0.01-1000 wt %, relative to the amount of the coating; preferably said amount is in the range of 0.05-500 wt %.

The conditions under which the process steps a)- c) have to be performed, are as such known in the art of radiation polymerization. As temperatures for said process steps preferably a temperature of between 175 and 375 K is used for step b), and preferably a temperature of between 300 and 575 K is used for step c).

The polymeric relief structures of the present invention have an improved aspect ratio as well as an improved sharpness. The aspect ratio (AR, being the ratio between the relief height, and the distance between neighbouring reliefs, both in pm) of the reliefs of the invention is in general at least 0.075, and more preferably at least 0.12; even more preferably, the AR is at least 0.2. The sharpness of the relief structure can be quantified by the maximum absolute value of the curvature k. The procedure to derive the curvature k from AFM measurements is as follows : (i) the shape of the relief structure is fitted with, for instance, a Boltzmann fit, (ii) the first and second derivative of the fit are calculated, (iii) the curvature k is calculated with:

$$k = \frac{{f}^{″} ( x )}{{( 1 + {{f}^{′} ( x )}^{2} )}^{3 / 2}}$$

The absolute maximum value for the curvature (I kₘₐₓ I) of the relief structures according to the invention is at least 0.35 and more preferably at least 0.45 and even more preferably 0.65 μm⁻¹ most preferred at least 0.7 μm¹⁻. Both parameters (aspect ratio and sharpness) are to be determined via atomic force microscopy (AFM).

The polymeric relief structures of the present invention are applicable in optical components. Examples thereof are quarter wave films and wire grid polarizes for applications in, e.g. LCD's or LED's. Also moth eye or lotus flower structures for self-cleaning surfaces are attainable herewith. Another, and preferred embodiment is the use of the polymeric relief structure as a master for replication purposes in organic or inorganic matter.

The invention is further elucidated with the following Examples and comparative experiments, which are not meant to restrict the invention.

### Comparative Experiment A

The photopolymer consisted of a mixture containing :(i) a polymer, polybenzylmethacrylate (Mw =70 kg/mol), 50% wt/wt and (ii) a multifunctional monomer, di-penta erythritol tetraacrylate, 50% wt/wt. To this mixture a photo-initiator was added (Irgacure 369, 4% wt/wt) and a thermal initiator which is active at 130° C. (dicumyl peroxide, 2,5-bis(tert-butyl peroxy)-2,5 dimethyl hexane). The complete mixture was dissolved in propylene glycol methyl ether acetate (25% wt/wt).

The dissolved mixture was doctor bladed on a glass substrate. After doctor blading, the substrate with the thin film (4-5 micron) was heated to 80° C. for 5 minutes to remove residual traces of solvent. A solid film was obtained onto the glass substrates with a glass transition temperature above room temperature (Tg >20° C.). A photomask with a grating (pitch =10 micron) was used in direct contact with the solid polymer film. An exposure to ultra-violet light (Xenon lamp, bandpass interferential filter, 365 nm, 0.1 J/cm²) was performed. Afterwards, a first heating step was performed at 80° C. (10 minutes) and a second heating step was performed at 130° C.(10 min.).

A relief structure was formed which was analysed using atomic force microscopy (AFM) (FIG. 1). The relief structure had a height of approximately 1.1 micron and has rounded features on the top of the relief structure, which do not accurately mimic the geometry of the photomask. The aspect ratio AR was 0.11 and the maximum value of the curvature was 0.3 μm¹⁻

[image]

### EXAMPLE 1

The photopolymer used was identical to comparative experiment A. The spincoating and exposure to ultra-violet light were performed identical to comparative experiment A.

After the exposure to UV-light, a film of silicon oil was applied to the substrate with the photopolymer film. The interfacial surface tension was reduced with 18 mJ/m²

Special care was taken to avoid dissolution of the oil into the photopolymer. Subsequently, the first and second heating steps were performed (see comparative experiment A). Afterwards, the silicon oil was removed by rinsing with heptane at room temperature.

A relief structure was formed which was analysed with AFM (FIG. 2). The relief structure had a height of approximately 1.9 micron. Moreover, very sharp features were observed at the top of the relief structure, which were excellent copies of the irradiated (transparent) regions of the photomask. The aspect ratio AR was 0.19 and the maximum value of the curvature was 0.8 μm⁻¹.

[image]

### Comparative Experiment B

The coated substrate of comparative experiment A was used for a holographic exposure (grating, pitch =1.2 micron, Argon Ion laser, 351 nm, 0.1 J/cm²). Afterwards, a first heating step was performed at 80° C. (10 minutes) and a second heating step was performed at 130° C. (10 min.).

A relief structure was formed which was analysed using atomic force microscopy (FIG. 3). The relief structure had a height of approximately 0.07 micron. The aspect ratio AR was 0.06.

[image]

### EXAMPLE II

The coated substrate of comparative experiment A was used. After a holographic exposure, under the same conditions as in comparative experiment B, a film of silicon oil was applied to the substrate with the photopolymer film. Special care was taken to avoid dissolution of the oil into the photopolymer. Subsequently, the first and second heating steps were performed (see comparative experiment B). Afterwards, the silicon oil was removed by rinsing with heptane at room temperature.

A relief structure was formed which was analysed with AFM (FIG. 4) The relief structure had a height of approximately 0.16 micron. The aspect 10 ratio AR was 0. 13.

[image]

1. Process for the preparation of a polymeric relief structure by
a) coating a substrate with a coating comprising one or more radiation-sensitive ingredients,
b) locally treating the coated substrate with electromagnetic radiation having a periodic or random radiation-intensity pattern, forming a latent image,
c) polymerizing and/or crosslinking the resulting coated substrate, wherein in step c) a compound (Cs) is present that reduces the interfacial tension of the coated substrate.

2. Process according to claim 1, wherein Cs is applied to the resulting coated substrate of step b).

3. Process according to claim 1, wherein Cs is already present in the coating used in step a).

4. Process according to claim 1, wherein the radiation-sensitive ingredient(s) in step a) comprise(s) one or more monomers, in combination with one or more polymerization initiators.

5. Process according to 1, wherein in step a) the coating also comprises a polymer.

6. Process according to claim 4, wherein the polymerization initiator is a mixture of a photo-initiator and a thermal initiator.

7. Process according to claim 1, wherein the coating is a solid film after evaporation of the volatile solvent.

8. Process according to claim 1, wherein a lithographic mask is used in direct contact with the photo-polymer film.

9. Process according to claim 1, wherein the electromagnetic radiation is UV-light in combination with a mask.

10. Process according to claim 1, wherein the treatment in step b) is by the use of light interference/holography.

11. Process according to claim 1, wherein the substrate comprises a polymer.

12. Process according to claim 5, wherein the polymer in the coating of step a) has a weight averaged molecular weight (Mw) of at least 20,000 g/mol.

13. Process according to claim 5, wherein the polymer in the coating of step a) has a glass transition temperature of at least 300 K.

14. Process according to claim 5, wherein the polymer is dissolved in the monomer (s) of the radiation-sensitive coating used in step a).

15. Process according to claim 1, wherein the ingredient (s) in the radiation-sensitive coating is/are selected from the group comprising (meth-)acrylates, epoxies, vinyl ethers, styrenes, and thiol-enes.

16. Process according to claim 1, wherein Cs reduces the interfacial tension with at least 10 mJ/m².

17. Process according to claim 1, wherein Cs is applied in an amount of from 0.05-5 wt %, relative to the amount of the coating.

18. Polymeric relief structure obtainable through a process according to claim 1.

19. Polymeric relief structure according to claim 18, wherein the aspect-ratio (AR) is at least 0.12, the AR being the ratio between the relief height and the distance between neighboring reliefs

20. Polymeric relief structure according to claim 18, wherein the maximum absolute value of the curvature (I k,ₘₐₓI) is at least 0.35, more preferably at least 0.45, and even more preferably at least 0.65 μm⁻¹.

21. Polymeric relief structure according to claim 18, wherein the AR is at least 0.2.

22. Polymeric relief structure according to claim 18, wherein I kₘₐₓ I is at least 0.7 μm⁻¹.

23. Process according to claim 1, wherein step b) is performed at a temperature between 175 and 375 K.

24. Process according to claim 1, wherein step c) is performed at a temperature of between 300 and 575 K.

25. A method of managing light comprising incorporating a polymeric relief structure according to claim 18 in a light-management element.

26. Method according to claim 25 wherein the Polymeric relief structure is incorporated in diffractive- or orholographic-optical elements.

27. A method for replication of organic or inorganic matter comprising using as a replication master a polymeric relief structure according to claim 18.
